(19) United States
(12) Patent Application Publication
(10) Pub. No.: US 2018/0198740 A1
(43) Pub. Date: Jul. 12, 2018

(54) SYSTEM AND METHOD FOR SHARING AND UPDATING CONTACT INFORMATION

(71) Applicant: David Rademacher, Bellevue, WA (US)

(72) Inventor: David Rademacher, Bellevue, WA (US)

(21) Appl. No.: 15/400,026

(22) Filed: Jan. 6, 2017

(51) Int. Cl. H04L 12/58; H04L 29/08

(52) U.S. Cl. CPC H04L 51/08; H04L 51/04; H04L 67/30; H04L 67/1095

(57) ABSTRACT

A contact sharing and updating system including at least one processor, a database for storing a plurality of contact records with contact information, and at least one computer-readable storage medium. The database for storing a plurality of contact records with contact information provides full one directional and optional mutual one-way-syncing-capability between electronic devices of a first-user and a second-user. The first-user is able to modify information related to the first-user; modifications being synchronized to the electronic device of the second-user. The first-user is able to provide a unique subset to the second-user and modify the subset at any time to the second-user.

### BACKGROUND

The present disclosure relates generally to a method of sharing and updating contact information. In particular, a mobile application for sharing and updating contact information between electronic devices is described.

Known methods of sharing and updating contact information are not entirely satisfactory for the range of applications in which they are employed. For example, existing methods of sharing and updating contact information do not provide optional syncing. In addition, conventional methods of sharing and updating contact information do not provide optional 2-way sync options between electronic devices.

Thus, there exists a need for a method of sharing and updating contact information that improve upon and advance the design of known sharing and updating contact information. Examples of new and useful methods of sharing and updating contact information relevant to the needs existing in the field are discussed below.

Disclosure addressing one or more of the identified existing needs is provided in the detailed description below. Examples of references relevant to methods of sharing and updating contact information include U.S. Patent and Publication References: U.S. Pat. Nos. 9,218,629, 8,825,784, 7,373,139, 8,296,351, 20030069746, and 20130217365.

### SUMMARY

The present disclosure is directed to a contact sharing and updating system including at least one processor, a database for storing a plurality of contact records with contact information, and at least one computer-readable storage medium. The database is configured for storing a plurality of contact records with contact information which provides full one directional and optional mutual one-way-syncing-capability between electronic devices of a first-user and a second-user. The first-user is able to modify information related to the first-user; modifications being synchronized to the electronic device of the second-user. The first-user is able to provide a unique subset to the second-user and modify the subset at any time to the second-user.

### BRIEF DESCRIPTION OF THE DRAWINGS

FIG. 1 is a flow illustration of the contact sharing and updating system of the present invention.

FIG. 2 is a first workflow diagram of the contact sharing and updating system shown in FIG. 1.

FIG. 3 is a second workflow diagram of the contact sharing and updating system as continued from FIG. 2.

FIG. 4 is a workflow diagram of a contact update as used in the present invention.

### DETAILED DESCRIPTION

The disclosed method of sharing and updating contact information between electronic devices will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various contact sharing and updating systems are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

Generally speaking, the present invention provides an individual with the ability to share all or a unique subset of their contact information with a second individual and control what elements in the subset of the first individuals contact information the second person is able to access. The first person is able to share business information, personal information, a combination of either or even a single item such as an email address. The first individual has the ability to add or delete information being provided in this subset at any time. This sharing is initiated by the first individual using a known piece of information belonging to the second person, most commonly an email address or mobile number. An html link is generated by the system and sent either via email or text by the first individual to the second individual.

A user account is then created for the second individual by the system with the first individual's chosen subset of information. This account uses the second individuals known article of information as a user name and creates a unique temporary password which is contained in the link sent to the second individual. The link provides the second individual an option to accept the account and synchronize (sync) the contact information of the first individual now located in the second individuals' account to the second individuals mobile device and/or email account. The method is for one-directional synchronizations. Even if both parties are synchronizing to each other, A to B and B to A, it is neither a “shared” nor ‘linked” synchronization. One user can choose at any time to stop synchronizing their own information updates to the second user but the second user may still elect to provide synchronized updates to the first individual. Contained within the same link as an alternative to accepting direct synchronization of the first individuals' information, the second individual can select to download the same subset of information provided by the first individual but as an electronic version commonly referred to as a vCard. Any future changes made by the first individual to any information provided in the subset to the second individual results in an updated vCard being automatically sent to the second individual as a replacement of the previous electronic vCard provided.

A system for sharing and updating contact information between electronic devices is disclosed herein, in a preferred embodiment, comprising: at least one processor, a database for storing a plurality of contact records with contact information, and at least one computer-readable storage medium. The contact information may be shared through a transmitted link from a first-user to a second-user via communicative association between the electronic devices (smartphones, or computers or other). The second-user is able to accept authorized sharing of the contact information provided by the first-user. The second-user is not required to accept and sync the contact information. If the second-user accepts the contact information the contact information is synced to the plurality of contact records of the second-user with the first-user having capability to manage and change the contact information as desired.

The first-user is able to update personal contact information online. The second-user is able to update personal contact information online if a user-profile is created. The database may be cloud-based in a preferred embodiment. The second-user is notified when the first-user updates the contact information of the first-user. The second-user is able to accept an electronic invite to synchronize the first-users information and by use of a pre-created account and a user-profile to create a one-directionally synced contact. The user-profile may be customizable via personal update feeds. The electronic invite and updates are able to be shown on a display screen of the electronic device(s).

The at least one computer-readable storage medium is configured to store one or more sequences of instructions which, when read by the at least one processor, causes the system to: send the electronic invite, create an account for the second user, provide the second user a delivery option of synchronization and alternately an electronic vCard, update the second-users the plurality of contact records of the first users the contact information, receive new contact information for one of the plurality of contact records if the electronic invite is accepted, update the contact record of one of the plurality of contact records in the database, and identify affected electronic devices within the plurality of electronic devices connected to the database such that syncing, if desired, is able to be achieved.

The database for storing a plurality of the contact records with the contact information provides full and optional mutual one-way-syncing capability between the electronic devices of the first-user and the second-user.

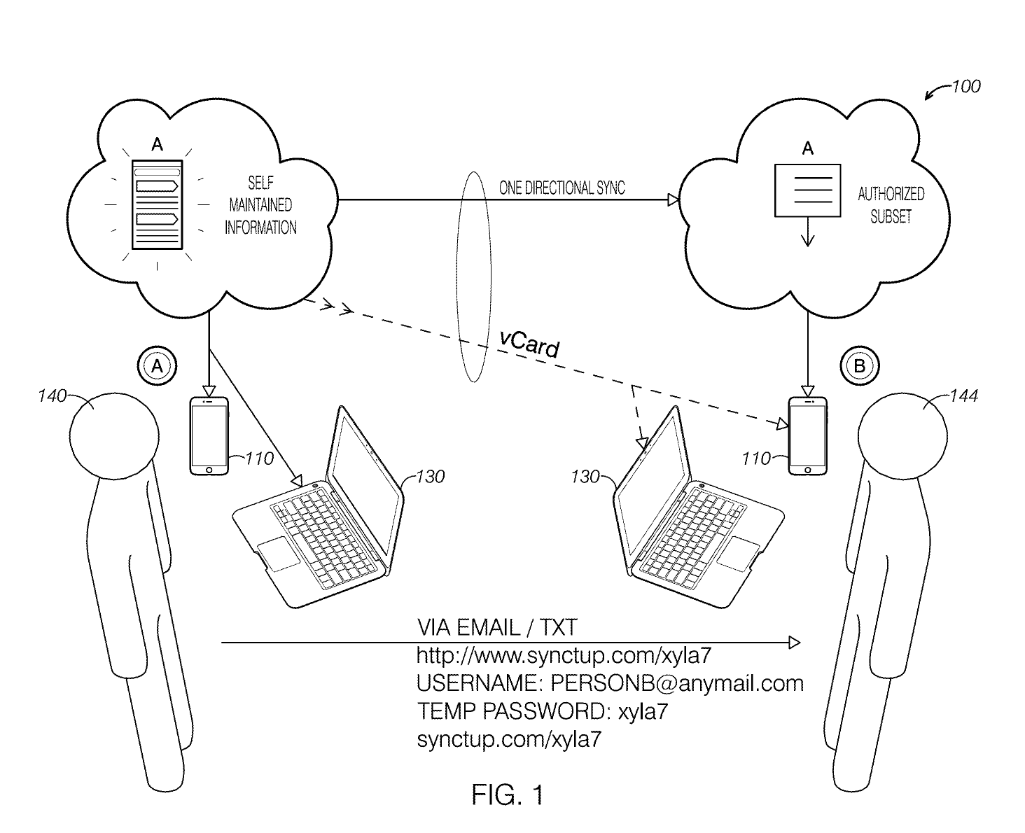

With reference to FIGS. 1-4, an example of a contact sharing and updating system 100, will now be described. Contact sharing and updating system 100 functions to provide full and optional mutual one-way-syncing capability between the electronic devices 110 of the first-user 140 and the second-user 144. The reader will appreciate from the figures and description below that contact sharing and updating system 100 addresses shortcomings of conventional methods of updating and sharing contact information.

For example, contact sharing and updating system 100 provides a method of sharing and updating contact information between electronic devices 110. Further, contact sharing and updating system 100 provides optional 2-way syncing of the contact information.

Contact sharing and updating system 100 includes at least one processor, a database for storing a plurality of contact records with contact information, and at least one computer-readable storage medium 130. The database for storing a plurality of contact records with contact information provides full one directional and optional mutual one-way-syncing-capability between electronic devices 110 of a first-user 140 and a second-user 144. The first-user 140 is able to modify information related to the first-user 140; modifications being synchronized to the electronic device 110 of the second-user 144. The first-user 140 is able to provide a unique subset to the second-user 144 and modify the subset at any time to the second-user 144.

In other examples, contact sharing and updating system 100 includes additional or alternative features, allowing a user to accept or deny invites regarding updating of contact information. The contact information may be shared through a transmitted link from a first-user 140 to a second-user 144 via communicative association between the electronic devices 110. The second-user 144 is able to accept authorized sharing of the contact information provided by the first-user 140. The second-user 144 is not required to accept and sync the contact information. If the second-user 144 accepts the contact information the contact information is synced to the plurality of contact records of the second-user 144 with the first-user 140 having capability to manage and change the contact information as desired. The first-user 140 is able to update personal the contact information online. The second-user 144 is able to update personal the contact information online if a user-profile is created.

The at least one computer-readable storage medium 130 is configured to store one or more sequences of instructions which, when read by the at least one processor, causes the system to: send an electronic invite, create an account for the second-user 144, provide the second-user 144 a delivery option of synchronization and alternately a vCard, update the second-user's the plurality of contact records of the first-user's 140 the contact information, receive new contact information for one of the plurality of contact records if the electronic invite is accepted, update the contact record of one of the plurality of contact records in the database, and identify affected electronic devices 110 within the plurality of electronic devices 110 connected to the database such that syncing if desired is able to be achieved.

The database for storing a plurality of the contact records with the contact information may provide full one directional and optional mutual one-way-syncing-capability between the electronic devices of the first-user 140 and the second-user 144. The first-user 140 is able to modify the information related to the first-user 140; modifications being synchronized to the electronic device of the second-user 144. The first-user 140 is able to provide a unique subset to the second-user 144 and modify the subset at any time to the second-user 144.

In a preferred embodiment the database may be cloud-based; however alternate means may be used. The database may comprise a local computer contact database. The first-user 140 is able to select a unique subset of the first-user's 140 information and send an authorization link to the second-user 144 with an option to one-way synchronize the first-user's 140 information directly to the second-user's electronic device and alternatively the second-user 144 can download a one-time electronic version v-card of the same subset of contact information. At the time of creating the transmitted link, the system creates a system account for the second-user 144 with the first-user's 140 authorized subset of information for the second-user's 144 use should the second-user choose a direct synchronization option of the first-user's 140 information to the second-user's 144 electronic device. The second-user 144 is able to optionally download a one-time electronic version vCard of contact information.

Should the first-user 140 add, subtract and alternately modify any of the information within the subset of authorized information, the system will send the second-user 144 an updated electronic vCard. A database of the second-user 144 is updated when the first-user 140 updates the contact information of the first-user 140. The second-user 144 is able to accept a pre-created user account by completing a user-profile. The second-user 144 may accept an electronic authorization and the user-profile. The contact information is imported from a digital-contact-system. The one-time electronic version of the contact information of the first-user 140 is automatically sent to the second-user 144 upon updating. The second-user 144 automatically receives an updated copy of the one-time electronic version of the contact information if the contact information has been updated since the one-time electronic version of the contact information was previously downloaded. The electronic invite and updates are able to be shown on a display screen of the electronic device(s) 110. If having the user-profile is established, synchronized-users are notified when the first-user 140 updates the contact information of the first-user 140. Members are able to add other members to the database using an identification number. In this way FIG. 1 shows an in-use condition using the present invention.

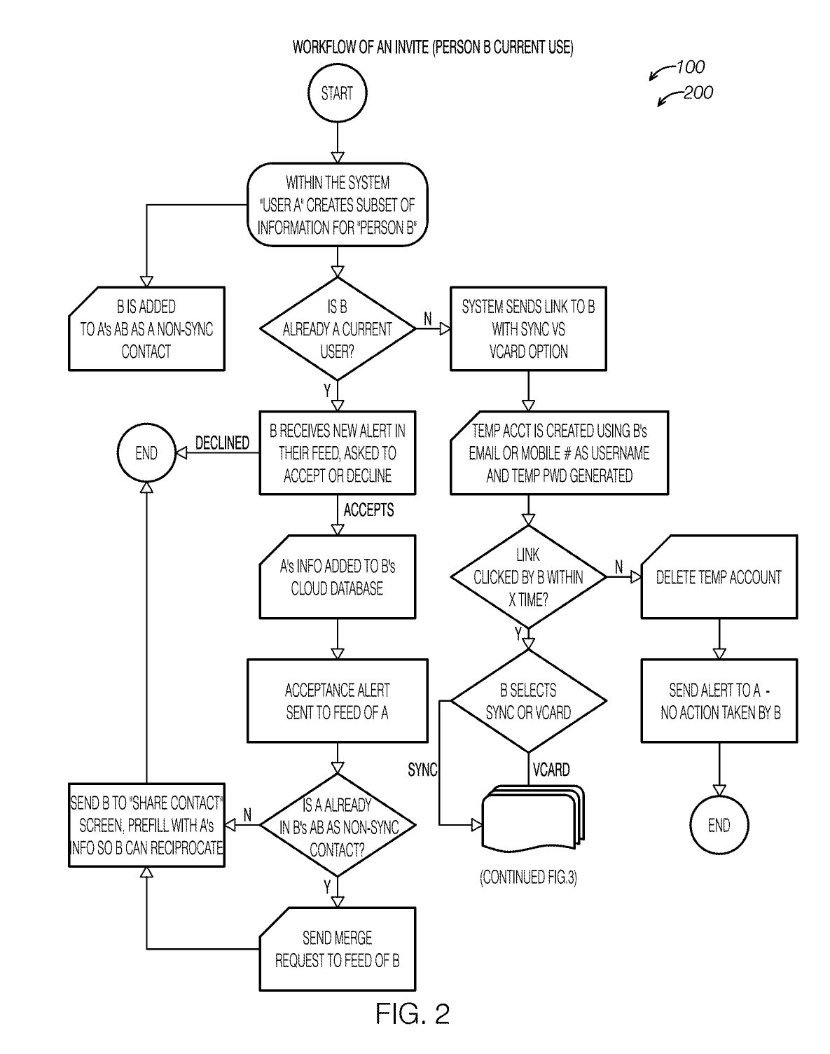

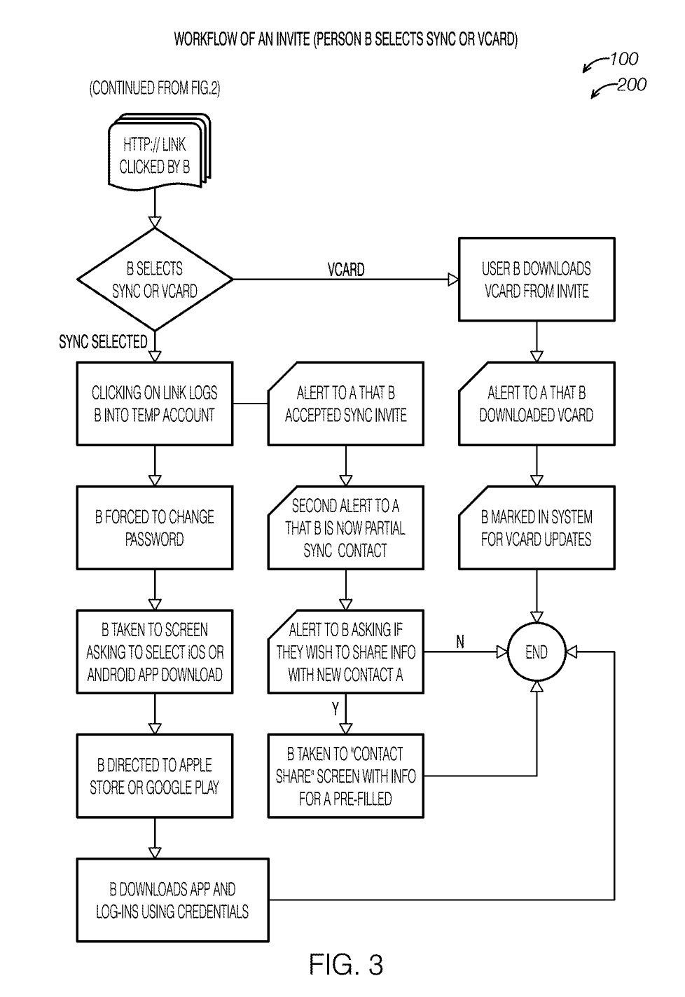

Turning attention to FIGS. 2 and 3, a first and second workflow diagram (respectively) of the contact sharing and updating system 200 shown in FIG. 1.

The workflow of an invite is shown comprising: start; within the system 200 first-user 140 creates a subset of information for second-user 144; a second-user 144 may then be added to first-user's 140 plurality of contact records as a non-sync contact, optionally, if second-user 144 is already a member second-user 144 receives a new alert in their feed asking to accept or deny an invite. If second-user 144 is not a user, a link may be sent to the second-user 144 with sync or vCard options. A user may then create a temporary account using an e-mail address. A link may be clicked by second-user 144 to sync or download a vCard. Optionally, a user may delete the temporary account and an alert will be sent to first-user 140 notifying first-user 140 that no action was taken by second-user 144. Referring now back to a user who is already a member, the alert may appear on their feed to accept or deny. If a user accepts the invite, contact information is added to second-user's 144 database. An acceptance alert may then be sent to the feed of the first-user 140. If first-user 140 is already in second-user's 144 contact records as a non-sync contact a message may be sent to merge request to feed of the second-user 144. Optionally, if the first-user 140 is not already in second-user's 144 contact records as a non-sync contact, second-user 144 contact information may be sent to a share contact screen and pre-fill with first-user's 140 information so second-user 144 can reciprocate.

As shown in FIG. 3 as a continuation of FIG. 2, after second-user 144 selects sync or vCard the second-user 144. If the user selects the sync option, the user may click on a link which then logs the second-user 144 into a temporary account. The second-user 144 may then change the password and be taken to a screen asking to select IOS or Android app download which may then direct second-user 144 to a download page. First-user 140 may be alerted if second-user 144 accepts an invite. A second alert may be sent to a first-user 140 if second-user 144 is now a partial sync contact. An alert may then be sent to second-user 144 asking if they wish to share info with new contact first-user 140. If the second-user 144 chooses the share, second-user 144 will be directed to a contact share screen with pre-filled info for first-user 140.

Referring to FIGS. 2 and 3, a second example of a contact sharing and updating system, contact sharing and updating system 200, will now be described with various options. System 200 includes many similar or identical features to contact sharing and updating system 100. Thus, for the sake of brevity, each feature of contact sharing and updating system 200 will not be redundantly explained. Rather, key distinctions between contact sharing and updating system 200 and contact sharing and updating system 100 will be described in detail and the reader should reference the discussion above for features substantially similar between the two methods of updating and sharing contact information with optional syncing.

As can be seen in FIG. 2, contact sharing and updating system 200 includes the option to accept or deny syncing of contact information. A user has the option to create a user-profile or simply accept a one-time contact information update in the form of a vCard.

Referring to FIGS. 2-3, methods 200 of using contact sharing and updating system will now be described. Method 200 includes sending an electronic invite from the electronic device 110 of a first-user 140 to a (electronic device 110 of) second-user 144, updating the electronic device 110 of the second user 144 if syncing, and alternately sending out a new vCard, notifying the second-user 144, if a member, of potential updates to contact information, receiving new-contact-information of the first-user 140 upon acceptance of the electronic invite by the second-user 144, and updating a contact record of the second-user 144 in a database. The electronic device 110 may comprise a smartphone, another mobile device, or personal computer, or the like. The database is configured for storing a plurality of the contact records with the contact information to provide full and optional dual one directional syncing capability between the electronic devices 110 of the first-user 140 and the second-user 144.

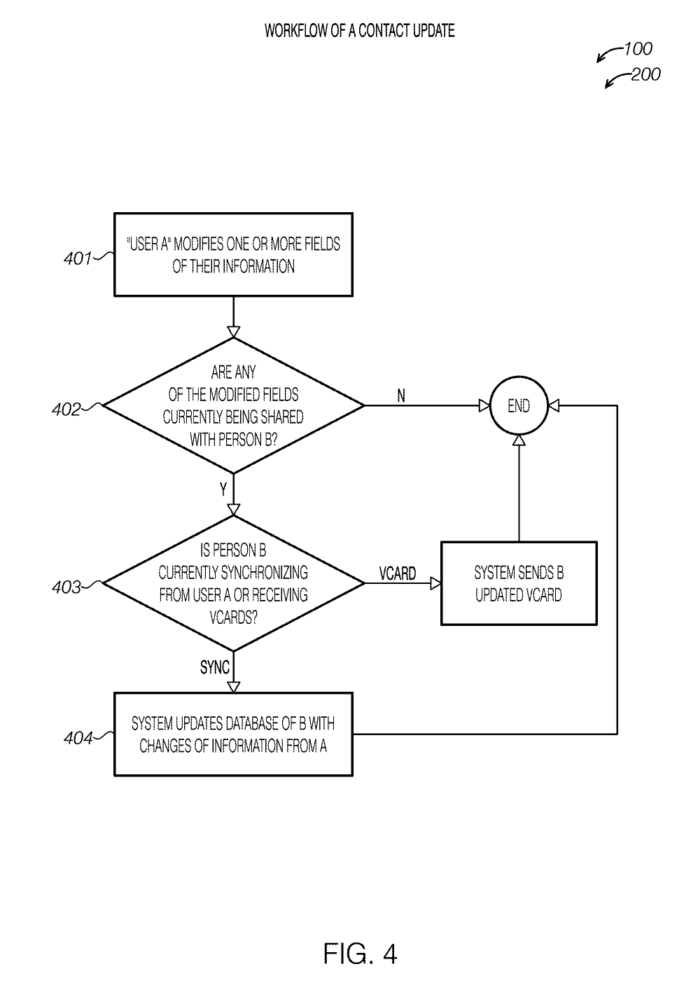

Referring now to FIG. 4, a workflow diagram of a contact update as used in the present invention. Step one 401 a first-user 140 may modify one of more fields of their personal contact information. Step two 402 if any of the modified fields are currently being shared with a second-user 144 and step three 403 second-user 144 is currently syncing from first-user 140, step four 404 the system will update the database of the second-user 144 with the first-user 140 modified information. If the second-user 144 is currently receiving vCards, the system will send second-user 144 an updated vCard.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A system for sharing and updating contact information between a sender and a recipient's electronic devices, comprising:
at least one processor;
a database for storing a plurality of contact records with contact information;
at least one computer-readable storage medium;
wherein said contact information is shared through a transmitted link from a first-user to a second-user via communicative association between said electronic devices;
wherein said second-user is able to accept authorized sharing of said contact information provided by said first-user;
wherein said second-user is not required to accept and sync said contact information;
wherein if said second-user accepts said contact information said contact information is synced to said plurality of contact records of said second-user with said first-user having capability to manage and change said contact information as desired;
wherein said first-user is able to update personal said contact information online;
wherein said second-user is able to update personal said contact information online if a user-profile is created;
wherein said at least one computer-readable storage medium is configured to store one or more sequences of instructions which, when read by said at least one processor, causes said system to:
send an electronic invite;
create an account for said second-user;
provide said second-user a delivery option of synchronization and alternately vCard;
update said second-user's said plurality of contact records of said first-user's said contact information;
receive new contact information for one of said plurality of contact records if said electronic invite is accepted;
update said contact record of one of said plurality of contact records in said database; and
identify affected said electronic devices within the plurality of electronic devices connected to said database such that syncing if desired is able to be achieved;
wherein said database for storing a plurality of said contact records with said contact information provides full one directional and optional mutual one-way-syncing-capability between said electronic devices of said first-user and said second-user;
wherein said first-user is able to modify said information related to said first-user, modifications being synchronized to said electronic device of said second-user; and
wherein said first-user is able to provide a unique subset to said second-user and modify said subset at any time to said second-user.

2. The system of claim 1, wherein said database is cloud-based.

3. The system of claim 1, wherein said database comprises a local computer contact said database.

4. The system of claim 1, wherein said first-user is able to select a unique subset of said first-users information and send an authorization link to said second-user with an option to one-way synchronize said first-users information directly to said second-users electronic device and alternatively said second-user can download a one-time electronic version v-card of same said subset of said contact information.

5. The system of claim 1, wherein at the time of creating said transmitted link, said system creates a system account for said second-user with said first-users authorized said subset of said information for said second-user use should said second-user choose a direct synchronization option of said first-users information to said second-user's electronic device.

6. The system of claim 1, wherein said second-user is able to optionally download a one-time electronic version said vCard of said contact information.

7. The system of claim 6, wherein should said first-user add, subtract and alternately modify any said information within said subset of authorized information, the system will send said second-user an updated electronic said vCard.

8. The system of claim 7, wherein a database of said second-user is updated when said first-user updates said contact information of said first-user.

9. The system of claim 8, wherein said second-user is able to accept a pre-created user account by completing a user-profile.

10. The system of claim 9, wherein said second-user is able to accept an electronic authorization and said user-profile.

11. The system of claim 1, wherein said contact information is imported from a digital-contact-system.

12. The system of claim 10, wherein said one-time electronic version of said contact information of said first-user is automatically sent to said second-user upon updating.

13. The system of claim 11, wherein said second-user automatically receives an updated copy of said one-time electronic version of said contact information if said contact information has been updated since said one-time electronic version of said contact information was previously downloaded.

14. The system of claim 13, wherein said electronic invite and updates are able to be shown on a display screen of said electronic device(s).

15. The system of claim 14, wherein if having said user-profile is established, synchronized-users are notified when said first-user updates said contact information of said first-user.

16. The system of claim 15, wherein members are able to add other said members to said database using an identification number.

17. A system for sharing and updating contact information between electronic devices, comprising:
at least one processor;
a database for storing a plurality of contact records with contact information; and
at least one computer-readable storage medium;
wherein said contact information is shared through a transmitted link from a first-user to a second-user via communicative association between said electronic devices;
wherein said second-user is able to accept authorized sharing of said contact information provided by said first-user;
wherein said second-user is not required to accept and sync said contact information;
wherein if said second-user accepts said contact information said contact information is synced to said plurality of contact records of said second-user with said first-user having capability to manage and change said contact information as desired;
wherein said first-user is able to update personal said contact information online;
wherein said second-user is able to update personal said contact information online if a user-profile is created;
wherein said database is cloud-based;
wherein said second-user is notified when said first-user updates said contact information of said first-user;
wherein said second-user is able to accept an electronic invite to synchronize said first-users information and by use of a pre-created account and a user-profile to create a one-directionally synced contact;
wherein said user-profile is customizable via personal update feeds;
wherein said electronic invite and updates are able to be shown on a display screen of said electronic device(s);
wherein said at least one computer-readable storage medium is configured to store one or more sequences of instructions which, when read by said at least one processor, causes said system to:
send said electronic invite;
create an account for said second user;
provide said second user a delivery option of synchronization and alternately an electronic vCard
update said second-users said plurality of contact records of said first users said contact information;
receive new contact information for one of said plurality of contact records if said electronic invite is accepted;
update said contact record of one of said plurality of contact records in said database; and
identify affected said electronic devices within the plurality of electronic devices connected to said database such that syncing if desired is able to be achieved; and
wherein said database for storing a plurality of said contact records with said contact information provides full and optional mutual one-way-syncing capability between said electronic devices of said first-user and said second-user.

18. The system of claim 17, wherein said electronic device comprises a smartphone.

19. The system of claim 18, wherein said electronic device comprises a personal computer.

20. A method for sharing and updating contact information between electronic devices comprising the steps of:
sending an electronic invite from said electronic device of a first-user to a second-user;
updating the electronic device of said second user if syncing, and alternately sending out a new vCard;
notifying said second-user, if a member, of potential updates to contact information;
receiving new-contact-information of said first-user upon acceptance of said electronic invite by said second-user; and
updating a contact record of said second-user in a database; and
wherein said database is configured for storing a plurality of said contact records with said contact information to provide full and optional dual one directional syncing capability between said electronic devices of said first-user and said second-user.
